(19) United States
(12) Patent Application Publication
(10) Pub. No.: US 2017/0123628 A1
(43) Pub. Date: May 4, 2017

(54) METHOD, DEVICE AND NAVIGATOR FOR VOICE COMMUNICATION

(71) Applicant: Leauto Intelligent Technology (BEIJING) Co., Ltd., Beijing (CN)

(72) Inventors: Wei Lin, Beijing (CN); Yu Zou, Beijing (CN); Yong Xu, Beijing (CN); WenRui Li, Beijing (CN); KunSheng Chen, Beijing (CN); Dan Li, Beijing (CN); Peng Liu, Beijing (CN); XiaoFei Gou, Beijing (CN)

(21) Appl. No.: 14/978,457

(22) Filed: Dec. 22, 2015

(30) Foreign Application Priority Data
Oct. 30, 2015 (CN) 201510728948.3

(51) Int. Cl. G06F 3/0481; H04W 4/02; G06F 3/16; H04W 76/02; G06F 3/0484; H04W 8/00; H04L 29/06

(52) U.S. Cl. CPC G06F 3/04817; H04W 8/005; H04W 4/023; H04L 65/1069; H04W 76/023; G06F 3/04842; G06F 3/167

(57) ABSTRACT

A method, device, and navigator for voice communication are disclosed. it is possible to enable the user to make voice communication by selecting the icon of the first vehicle displayed in the map, which is convenient and without acknowledging the phone number or social account of the other party by displaying icons of respective vehicles in a map according to positions of respective vehicles, then determining a first vehicle corresponding to an icon of the first vehicle selected by the user in the map, and establishing a voice communication with the first vehicle based on V2X communication.

### CROSS-REFERENCE TO RELATED APPLICATIONS

This application is based on and claims priority to Chinese Patent Application No. 201510728948.3, with the title of “METHOD, DEVICE AND NAVIGATOR FOR VOICE COMMUNICATION”, filed on Oct. 30, 2015, the full disclosure of which is hereby incorporated by reference in its entirety.

### FIELD OF TECHNOLOGY

The present disclosure relates to electronic technologies, and particularly to a method, a device, and a navigator for voice communication.

### BACKGROUND

During the driving of vehicles, if users need to communicate in voice, in the related art, it is common that the user makes phone call with a mobile phone or use a social application in the mobile phone.

However, the inventors find that the methods in related art have at least the following problems: regarding the manner of using a mobile phone to make a phone call, it is necessary to know the phone number of the other party. On the real road, if the user needs to make a voice communication with the users in nearby vehicles, it may not be able to make such voice communication if the phone number of the other party cannot be obtained in advance. Similar problems exit in the manner of using the social application. It is common that the social applications need the social accounts or the like of the other party, which may be impossible in the application scenario where the user needs to make a voice communication with the users of nearby vehicles.

Therefore, in the prior art, it may be impossible to make voice communications with users in nearby vehicles by the manner that the user makes a phone call with a mobile phone or uses the social applications in the mobile phone.

### SUMMARY

The embodiments of the present disclosure provide a method, a device, and a navigator for voice communication, which may be used to make voice communications with the users in nearby vehicles.

In the first aspect, there is provided a method for voice communication including: displaying icons of respective vehicles in a map according to positions of respective vehicles; determining a first vehicle corresponding to an icon of the first vehicle selected by the user in the map; establishing a voice communication with the first vehicle based on V2X (Vehicle to X) communication.

In the second aspect, there is provided a device for voice communication including: a displaying module configured to display icons of respective vehicles in the map according to positions of respective vehicles; a determining module configured to determine a first vehicle corresponding to an icon of the first vehicle selected by the user in the map; a voice-communication module configured to establish a voice communication with the first vehicle based on V2X (Vehicle to X) communication.

In the third aspect, there is provided a device for voice communication, comprising: one or more processors; a memory; and one or more programs stored in the memory and configured to perform operations when executed by the one or more processors, wherein the operations comprises: displaying icons of respective vehicles in a map according to positions of the respective vehicles; determining the first vehicles corresponding to icons of the first vehicles selected by the user in the map; and establishing a voice communication with the first vehicle based on V2X (Vehicle to X) communication.

In the fourth aspect, there is provided a navigator including the device for voice communication as described above.

According to the method, device, and navigator for voice communication, it is possible to enable the user to make voice communication by selecting the icon of the first vehicle displayed in the map, which is convenient and without acknowledging the phone number or social account of the other party by displaying icons of respective vehicles in a map according to positions of respective vehicles, then determining a first vehicle corresponding to an icon of the first vehicle selected by the user in the map, and establishing a voice communication with the first vehicle based on V2X communication.

### BRIEF DESCRIPTION OF THE DRAWINGS

FIG. 1 is a flowchart of a method for voice communication provided by a first embodiment of the present disclosure;

FIG. 2 is a flowchart of another method for voice communication provided by a second embodiment of the present disclosure;

FIG. 3 is a structural view of a device for voice communication provided by a third embodiment of the present disclosure;

FIG. 4 is a structural view of another device for voice communication provided by a fourth embodiment of the present disclosure;

FIG. 5 is a structural view of still another device for voice communication provided by the fifth embodiment of the present disclosure; and

FIG. 6 is a structural view of an embodiment of a device for voice communication provided by the present disclosure.

### DETAILED DESCRIPTION

Detailed description is given below for the method, device, and navigator for displaying positions of vehicles provided by the embodiments of the present disclosure in connection with the drawings.

### First Embodiment

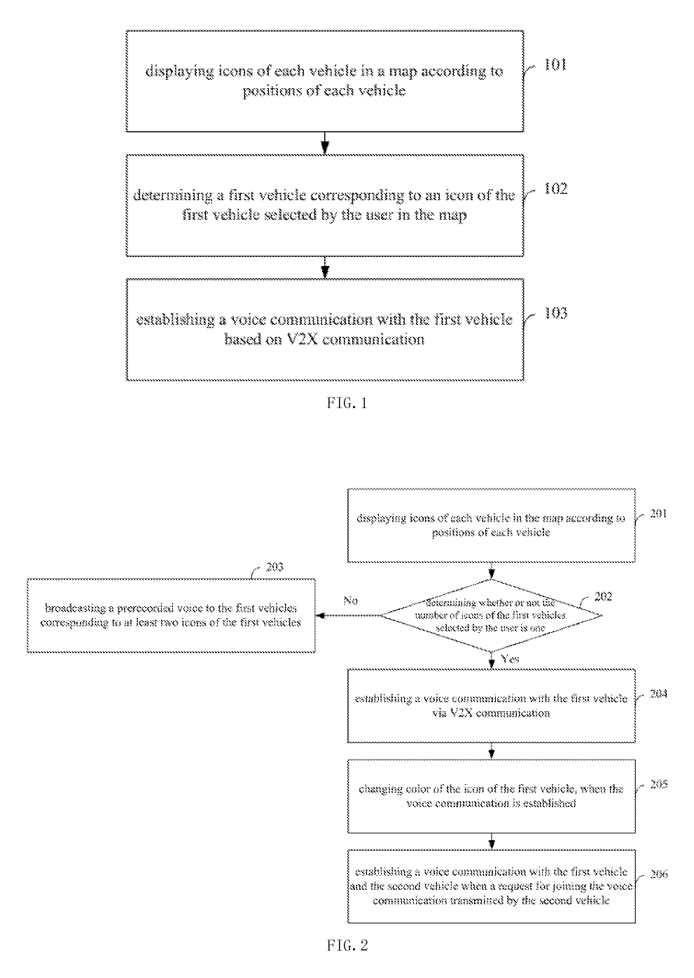

FIG. 1 is a flowchart of a method for voice communication provided by the first embodiment of the present disclosure. The method provided by the embodiment of the present disclosure may be performed by an on-vehicle device, which may be a navigator. As shown in FIG. 1, the method may include:

Step 101: displaying icons of respective vehicles in a map according to positions of respective vehicles.

More particularly, a user may visibly acknowledge the positions of nearby vehicles by receiving positions of respective vehicles broadcast by each vehicle via V2X communication and displaying icons of respective vehicles at the positions of respective vehicles in the map. This is because the V2X communication is a kind of short-range communication, and thus based on the positions of vehicles, particularly the positions of nearby vehicles, received via V2X communication, and icons of vehicles displayed in the map, the driver may acknowledge positions of nearby vehicles even in a region with a narrow visual field, and the safety in driving may be improved.

Step 102: determining a first vehicle corresponding to an icon of the first vehicle selected by the user in the map. More particularly, the user may select an icon of a vehicle by clicking the icon of the vehicle in the map for subsequent operations. The on-vehicle device may mark the selected icon as the icon of the first vehicle by acknowledging that the user has selected the icon of the vehicle in the map through a touch sensor.

Step 103: establishing a voice communication with the first vehicle based on V2X communication. More particularly, the on-vehicle device may transmit a request for voice communication to the first vehicle via V2X communication, and then enter a waiting period, which may last about 5-10 s. The on-vehicle device may establish a communication connection with the first vehicle if a response for voice communication transmitted by the first vehicle is received during such waiting period. If a response for voice communication transmitted by the first vehicle has not been received during such waiting period, which may include the case of receiving a communication failure signal indicating that the request for voice communication is rejected, it may be indicated that the communication is failed.

Furthermore, after the step 101, the method may further include: changing the color of the icon of a third vehicle corresponding to the third vehicle in the map when a request for voice communication transmitted by the third vehicle is received.

More particularly, there is a “Do not Disturb” button provided on the interface displaying the map. When the on-vehicle device determines that the “Do not Disturb” button is in an unselected state and a request for voice communication transmitted by the third vehicle is received, the color of the icon of a third vehicle corresponding to the third vehicle may be changed in the map, and may further make an indication with sound, so that the user may make choice to reject the communication, accept the communication or refuse to response. If the user makes choice to reject the communication, a communication failure signal indicating that the request for voice communication is rejected may be transmitted to the third vehicle. If the user makes choice to accept the communication, a response for voice communication indicating that the request for voice communication is accepted may be transmitted to the third vehicle. When it is determined that the “Do not Disturb” button is in a state of being selected by the user on the interface displaying the map, the on-vehicle device may refuse to accept the request for voice communication, and a communication failure signal indicating that the request for voice communication is rejected may be transmitted to the third vehicle.

According to the present embodiment, it is possible to enable the user to make voice communication by selecting the icon of the first vehicle displayed in the map, which is convenient and without acknowledging the phone number or social account of the other party by displaying icons of respective vehicles in a map according to positions of respective vehicles, then determining a first vehicle corresponding to an icon of the first vehicle selected by the user in the map, and establishing a voice communication with the first vehicle based on V2X communication.

### Second Embodiment

FIG. 2 is a flowchart of another method for voice communication provided by the second embodiment of the present disclosure. The method provided by the embodiment of the present disclosure may be performed by an on-vehicle device, which may be a navigator. As shown in FIG. 2, the method may include:

Step 201: displaying icons of respective vehicles in the map according to positions of respective vehicles. More particularly, the on-vehicle device may receive positions of respective vehicles broadcast by each vehicle via V2X communication, and display icons of respective vehicles at positions of respective vehicles in the map.

Step 202: determining the number of icons of the first vehicles selected by the user. If the number is one, steps 204-206 may be performed, otherwise, step 203 may be performed.

When the on-vehicle device acknowledges that the user has selected the icons of the first vehicles by a touch sensor, the number of selected icons of the first vehicles may be determined. If the number of selected icons of the first vehicles is one, the on-vehicle device may establish voice communication with the first vehicle via V2X communication. Otherwise, the on-vehicle device may broadcast voice to the first vehicles corresponding to at least two icons of the first vehicles. The frequency for transmitting the voice, i.e., the frequency for voice communication, may be automatically set according to the actual data requirement.

Step 203, broadcasting a prerecorded voice to the first vehicles corresponding to at least two icons of the first vehicles.

More particularly, the on-vehicle device may prerecord a voice and store the same in the on-vehicle device and may also record a voice before transmitting a voice and store the same in a memory of the on-vehicle device. As a possible implementation, when it is determined that the number of icons of the first vehicles are at least two, the user may be requested to record a voice or to select at least one voice from the stored voices, and then the voice may be read out from the memory and broadcast to at least two first vehicles.

Step 204, establishing a voice communication with the first vehicle via V2X communication. More particularly, when a response for voice communication indicating the communication is accepted transmitted by the first vehicle is received, the on-vehicle device may establish a voice communication, display a chat room interface corresponding to the voice communication, on which the plate number, vehicle model, vehicle color, and nickname of user and the like may be displayed.

Step 205, changing color of the icon of the first vehicle, when the voice communication is established. More particularly, the color of the icon of the first vehicle may be different before and after the establishment of the voice communication, and the user may acknowledge the stage of establishing the voice communication by observing the color of the icon of the first vehicle.

Step 206, establishing a voice communication with the first vehicle and the second vehicle when a request for joining the voice communication transmitted by the second vehicle. More particularly, when a second vehicle requests to join the voice communication, a voice communication in a conference call mode may be established and the plate number, vehicle model, vehicle color and nickname of user and the like of the second vehicle may be additionally displayed on the chat room interface.

According to the present embodiment, it is possible to enable the user to make voice communication by selecting the icon of the first vehicle displayed in the map, which is convenient and without acknowledging the phone number or social account of the other party by displaying icons of respective vehicles in a map according to positions of respective vehicles, then determining a first vehicle corresponding to an icon of the first vehicle selected by the user in the map, and establishing a voice communication with the first vehicle based on V2X communication. Furthermore, it is also possible to perform a various kinds of voice communication such as three-party or multi-party communication and broadcasting and the like, and thus the flexibility of voice communication may be improved and the functions of the on-vehicle device may be enriched.

### Third Embodiment

FIG. 3 is a structural view of a device for voice communication provided by the third embodiment of the present disclosure. As shown in FIG. 3, the device may include: a displaying module 31, a selecting module 32, and a voice communication module 33.

The displaying module 31 may be configured to display icons of respective vehicles in the map according to positions of respective vehicles. More particularly, the displaying module 31 may receive positions of respective vehicles broadcast by each vehicle via V2X communication and display icons of respective vehicles at the positions of respective vehicles in the map, thereby the user may visibly acknowledge the positions of nearby vehicles. This is because the V2X communication is a kind of short-range communication, and thus based on the positions of vehicles, particularly the positions of nearby vehicles, received via V2X communication, and icons of vehicles displayed in the map, the driver may acknowledge positions of nearby vehicles even in a region with a narrow visual field, and the safety in driving may be improved.

The selecting module 32 may be connected with the displaying module 31 and configured to determine a first vehicle corresponding to an icon of the first vehicle selected by the user in the map. More particularly, the user may select an icon of a vehicle by clicking the icon of the vehicle in the map for subsequent operations. The selecting module 32 may mark the selected icon as the icon of the first vehicle by acknowledging that the user has selected the icon of the vehicle in the map through a touch sensor.

The voice communication module 33 may be connected with the selecting module 32 and configured to establish a voice communication with the first vehicle based on V2X communication. More particularly, the voice communication module 33 may transmit a request for voice communication to the first vehicle via V2X communication, and then may establish a communication connection with the first vehicle if a response for voice communication transmitted by the first vehicle is received.

According to the present embodiment, it is possible to enable the user to make voice communication by selecting the icon of the first vehicle displayed in the map, which is convenient and without acknowledging the phone number or social account of the other party by displaying icons of respective vehicles in a map according to positions of respective vehicles, then determining a first vehicle corresponding to an icon of the first vehicle selected by the user in the map, and establishing a voice communication with the first vehicle based on V2X communication.

### Fourth Embodiment

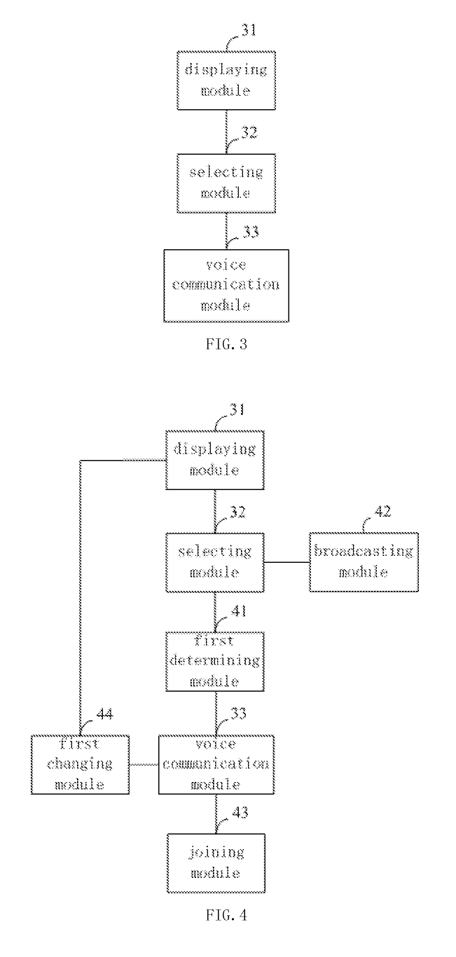

FIG. 4 is a structural view of another device for voice communication provided by the fourth embodiment of the present disclosure. Based on the device for voice communication provided by the third embodiment, in the present embodiment, the device further includes: a first determining module 41 and a broadcasting module 42.

The first determining module 41 may be connected with the selecting module 32 and the voice communication module 33 and configured to determine that the number of icons of the first vehicles selected by the user in the map is one before the voice communication with the first vehicle is established.

Based on this, the device for voice communication may further include a broadcasting module 42.

The broadcasting module 42 may be connected with the selecting module 32 and configured to broadcast a prerecorded voice to the first vehicles corresponding to at least two icons of the first vehicles via V2X communication, when it is determined that the number of icons of the first vehicles selected by the user in the map is at least two.

More particularly, the first determining module 41 may determine the number of the icons of the first vehicles when acknowledging that the user has selected the icons of the first vehicles through a touch sensor. If the number of selected icons of the first vehicles is one, the on-vehicle device may establish voice communication with the first vehicle via V2X communication. Otherwise, the broadcasting module 42 may broadcast a prerecorded voice to the first vehicles corresponding to at least two icons of the first vehicles via V2X communication.

Furthermore, the device for voice communication may further include a joining module 43 and a first changing module 44.

The joining module 43 may be connected with the voice communication module 33 and configured to establish a voice communication with the first vehicle and the second vehicle when a request for joining the voice communication transmitted by the second vehicle is received.

The first changing module 44 may be connected with the displaying module 31 and the voice communication module 33 and configured to change color of the icon of the first vehicle.

According to the present embodiment, it is possible to enable the user to make voice communication by selecting the icon of the first vehicle displayed in the map, which is convenient and without acknowledging the phone number or social account of the other party by displaying icons of respective vehicles in a map according to positions of respective vehicles, then determining a first vehicle corresponding to an icon of the first vehicle selected by the user in the map, and establishing a voice communication with the first vehicle based on V2X communication. Furthermore, it is also possible to perform a various kinds of voice communication such as three-party or multi-party communication and broadcasting and the like, and thus the flexibility of voice communication may be improved and the functions of the on-vehicle device may be enriched.

### Fifth Embodiment

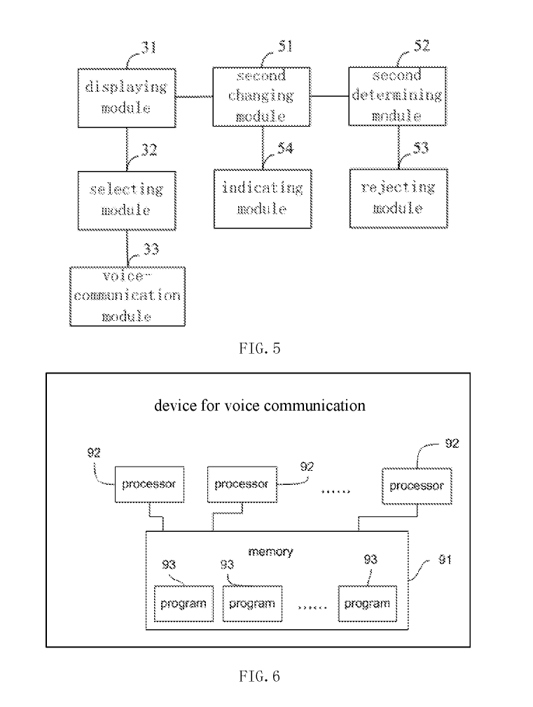

FIG. 5 is a structural view of still another device for voice communication provided by the fifth embodiment of the present disclosure. Based on the device for voice communication provided by the third embodiment, in the present embodiment, the device further includes: a second changing module 51 and an indicating module 54.

The second changing module 51 may be connected with the displaying module 31 and configured to change the color of the icon of a third vehicle corresponding to the third vehicle in the map when a request for voice communication transmitted by the third vehicle is received.

The indicating module 54 may be connected with the second changing module 51 and configured to make an indication with sound after changing the color of the icon of the third vehicle.

Optionally, a “Do not Disturb” button may be provided on the interface displaying the map. Therefore, the device for voice communication may further include: a second determining module 52 and a rejecting module 53.

The second determining module 52 may be connected with the second changing module 51 and configured to determine that the “Do not Disturb” button is in an unselected state before the color of the icon of a third vehicle corresponding to the third vehicle may be changed in the map, wherein the “Do not Disturb” button may be provided on the interface displaying the map.

The rejecting module 53 may refuse to accept the request for voice communication, when it is determined that the “Do not Disturb” button is in a state of being selected by the user on the interface displaying the map.

According to the present embodiment, it is possible to enable the user to make voice communication by selecting the icon of the first vehicle displayed in the map, which is convenient and without acknowledging the phone number or social account of the other party by displaying icons of respective vehicles in a map according to positions of respective vehicles, then determining a first vehicle corresponding to an icon of the first vehicle selected by the user in the map, and establishing a voice communication with the first vehicle based on V2X communication. Furthermore, it is also possible to perform a various kinds of voice communication such as three-party or multi-party communication and broadcasting and the like, and thus the flexibility of voice communication may be improved and the functions of the on-vehicle device may be enriched.

### Sixth Embodiment

The embodiment of the present disclosure may provide a navigator including the device for voice communication provided by the foregoing embodiment.

More particularly, the navigator may store a map in advance. The navigator may receive position of first vehicle broadcast by the first vehicle via V2X communication and display icon of the first vehicle at the position corresponding to the first vehicle in the map. Then the navigator may determine the first vehicle corresponding to the icon of the first vehicle selected by the user in the map and establish a voice communication with the first vehicle via V2X communication.

Furthermore, after establishing the voice communication with the first vehicle, when a request for joining the voice communication transmitted by a second vehicle, the navigator may establish the voice communication with the first vehicle and the second vehicle.

Optionally, when it is determined that the number of icons of the first vehicles selected by the user in the map is at least two, the navigator may broadcast a prerecorded voice to the first vehicles corresponding to at least two icons of the first vehicles via V2X communication.

Furthermore, the navigator may determine whether or not the “Do not Disturb” button is in a selected state when receiving a request for voice communication transmitted by the third vehicle. If so, the request for voice communication may be rejected; otherwise, the color of the icon of a third vehicle corresponding to the third vehicle may be changed in the map, and an indication with sound may be made so that the user may make choice whether or not to perform the voice communication. When the user makes the choice to perform the voice communication, the voice communication with the third vehicle may be established.

The hardware structure of the navigator in the present embodiment may include a locating module, a navigator module, and a V2X communication circuit, as well as a touch display, a microphone, and a speaker. The touch display may display icons of respective vehicles in the map according to positions of respective vehicles and then determine the vehicles corresponding to the icons of the vehicles selected by the user in the map. The V2X communication circuit may further transmit a request for voice communication to the vehicle via V2X communication and the voice communication with the vehicle may be established when the V2X communication circuit receives response for voice communication transmitted by the vehicle. Furthermore, in the communication connection, the voice of the user may be acquired by the microphone and the received voice may be played with the speaker, so as to perform the voice communication with nearby vehicles.

According to the present embodiment, it is possible to enable the user to make voice communication by selecting the icon of the first vehicle displayed in the map, which is convenient and without acknowledging the phone number or social account of the other party by displaying icons of respective vehicles in a map according to positions of respective vehicles, then determining a first vehicle corresponding to an icon of the first vehicle selected by the user in the map, and establishing a voice communication with the first vehicle based on V2X communication. Furthermore, it is also possible to perform a various kinds of voice communication such as three-party or multi-party communication and broadcasting and the like, and thus the flexibility of voice communication may be improved and the functions of the on-vehicle device may be enriched.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A method for voice communication, comprising:
displaying icons of respective vehicles in a map according to positions of the respective vehicles;
determining the first vehicles corresponding to icons of the first vehicles selected by the user in the map; and
establishing voice communications with the first vehicles based on V2X (Vehicle to X) communication.

2. The method for voice communication according to claim 1, wherein before establishing voice communications with the first vehicles based on V2X communication, the method further comprises: determining that the number of icons of the first vehicles selected by the user in the map is one,
wherein the method further comprises: broadcasting a prerecorded voice to the first vehicles corresponding to at least two icons of the first vehicles via V2X communication, when it is determined that the number of icons of the first vehicles selected by the user in the map is at least two.

3. The method for voice communication according to claim 1, wherein the establishing voice communication with the first vehicles based on V2X communication comprises:
transmitting a request for voice communication to the first vehicles via V2X communication; and
establishing communication connections with the first vehicles by an on-vehicle device when receiving a response for voice communication transmitted by the first vehicle.

4. The method for voice communication according to claim 1, wherein after establishing voice communications with the first vehicles based on V2X communication, the method further comprises:
establishing the voice communications with the first vehicles and a second vehicle when receiving a request of joining the voice communication transmitted by the second vehicle.

5. The method for voice communication according to claim 1, wherein after establishing voice communications with the first vehicles based on V2X communication, the method further comprises:
changing colors of the icons of the first vehicles.

6. The method for voice communication according to claim 1, wherein after displaying icons of respective vehicles in a map according to positions of respective vehicles, the method further comprises:
changing colors of an icon of a third vehicle corresponding to the third vehicle in the map when receiving a request for voice communication transmitted by the third vehicle.

7. The method for voice communication according to claim 6, wherein before changing colors of icons of the third vehicles corresponding to the third vehicle in the map when receiving a request for voice communication transmitted by the third vehicle, the method further comprises:
determining that a “Do not Disturb” button is in an unselected state, wherein the “Do not Disturb” button is provided on the interface displaying the map, and
the method further comprises:
refusing to accept the request for voice communication, when it is determined that the “Do not Disturb” button is in a state of being selected by the user on the interface displaying the map.

8. The method for voice communication according to claim 6, wherein after changing colors of icons of the third vehicles corresponding to the third vehicle in the map, the method further comprises:
making an indication with sound.

9. A device for voice communication, comprising:
one or more processors;
a memory; and
one or more programs stored in the memory and configured to perform operations when executed by the one or more processors, wherein the operations comprise:
displaying icons of respective vehicles in a map according to positions of the respective vehicles;
determining the first vehicles corresponding to icons of the first vehicles selected by the user in the map; and
establishing voice communications with the first vehicles based on V2X (Vehicle to X) communication.

10. The device for voice communication according to claim 9, wherein the operations further comprise:
before establishing voice communications with the first vehicles based on V2X communication, the operations further comprise: determining that the number of icons of the first vehicles selected by the user in the map is one, and
wherein the operations further comprise: broadcasting a prerecorded voice to the first vehicles corresponding to at least two icons of the first vehicles via V2X communication, when it is determined that the number of icons of the first vehicles selected by the user in the map is at least two.

11. The device for voice communication according to claim 9, wherein the establishing voice communications with the first vehicles based on V2X communication comprises:
transmitting a request for voice communication to the first vehicles via V2X communication; and
establishing communication connections with the first vehicles by an on-vehicle device when receiving a response for voice communication transmitted by the first vehicle.

12. The device for voice communication according to claim 9, wherein after establishing voice communications with the first vehicles based on V2X communication, the operations further comprise:
establishing the voice communication with the first vehicles and a second vehicle when receiving a request of joining the voice communication transmitted by the second vehicle.

13. The device for voice communication according to claim 9, wherein after establishing a voice communication with the first vehicle based on V2X communication, the operations further comprise:
changing colors of the icons of the first vehicles.

14. The device for voice communication according to claim 9, wherein after displaying icons of respective vehicles in a map according to positions of respective vehicles, the operations further comprise:
changing colors of an icon of a third vehicle corresponding to the third vehicle in the map when receiving a request for voice communication transmitted by the third vehicle.

15. The device for voice communication according to claim 14, wherein before changing colors of icons of the third vehicles corresponding to the third vehicle in the map when receiving a request for voice communication transmitted by the third vehicle, the operations further comprise:
determining that a “Do not Disturb” button is in an unselected state, wherein the “Do not Disturb” button is provided on the interface displaying the map, and
the operations further comprise:
refusing to accept the request for voice communication, when it is determined that the “Do not Disturb” button is in a state of being selected by the user on the interface displaying the map.

16. The device for voice communication according to claim 14, wherein after changing colors of icons of the third vehicles corresponding to the third vehicle in the map, the operations further comprise:
making an indication with sound.

17. A navigator, comprising the device for voice communication according to claim 9.

18. A navigator, comprising the device for voice communication according to claim 10.

19. A navigator, comprising the device for voice communication according to claim 11.

20. A navigator, comprising the device for voice communication according to claim 12.
